(19) United States
(12) Patent Application Publication
(10) Pub. No.: US 2026/0287375 A1
(43) Pub. Date: Sep. 24, 2026

(54) CHARGING ROUTE PLANNING METHOD AND ROUTE PROCESSING APPARATUS

(71) Applicant: Wistron Corporation, New Taipei City (TW)

(72) Inventors: Chih Lin Hu, Taoyuan (TW); Wai Hin Leung, Taoyuan (TW); Huan Wei Shen, Taoyuan (TW)

(73) Assignee: Wistron Corporation, New Taipei City (TW)

(21) Appl. No.: 19/182,619

(22) Filed: Apr. 18, 2025

(30) Foreign Application Priority Data
Mar. 24, 2025 (TW) 114110929

(51) Int. Cl. G01C 21/34; B60L 53/66

(52) U.S. Cl. CPC G01C 21/3469; B60L 53/66; B60L 2240/60

(57) ABSTRACT

A charging route planning method and a route processing apparatus are provided. A charging request message is detected. The charging request message corresponds to task period information, and the task period information indicates the initiation time of the charging request message. Battery information is detected. The battery information indicates the current battery level. Reference route information is obtained. The reference route information indicates the route from the current location that issued the charging request message to multiple charging stations. Target route information is determined based on the charging request message, the battery information, and the reference route information. The target route information indicates the route from the current location to the target station among multiple charging stations. Therefore, charging efficiency could be improved.

### CROSS-REFERENCE TO RELATED APPLICATION

This application claims the priority benefit of Taiwan application serial no. 114110929, filed on Mar. 24, 2025. The entirety of the above-mentioned patent application is hereby incorporated by reference herein and made a part of this specification.

### BACKGROUND

### Technical Field

This disclosure relates to an information processing technology related to routes, and particularly relates to a charging route planning method and a route processing apparatus.

### Description of Related Art

In recent years, with the rise of environmental awareness and government policy promotion, the quantity of electric vehicles continues to grow; however, the construction of charging infrastructure has not been able to keep up, causing electric vehicle users to frequently face charging problems. For example, public transportation can only charge at designated charging stations after completing tasks, this arrangement lacks flexibility, and may also cause peak usage of charging piles and delay blockages.

### SUMMARY

The disclosure provides a charging route planning method and a route processing apparatus, capable of referring to various factors to provide appropriate charging route recommendations.

The charging route planning method of the embodiment of the disclosure is configured for a processor. The planning method includes (but is not limited to) the following. A charge request message is detected, wherein the charge request message corresponds to a task period information, and the task period information indicates an initiation time of the charge request message. A battery information is detected, wherein the battery information indicates a current battery level. A reference route information is obtained, wherein the reference route information indicates a route from a current location where the charge request message is issued to multiple charging stations. A target route information is decided according to the charge request message, the battery information, and the reference route information, wherein the target route information indicates from the current location to a target station among the charging stations.

The route processing apparatus of the embodiment of the disclosure includes (but is not limited to) a memory and a processor. The memory stores a program code. The processor is coupled to the memory. The processor loads the program code and executes: detecting a charge request message; detecting a battery information, wherein the battery information indicates a current battery level; obtaining a reference route information; and deciding a target route information according to the charge request message, the battery information, and the reference route information. The charge request message corresponds to a task period information, and the task period information indicates an initiation time of the charge request message. The reference route information indicates a route from a current location where the charge request message is issued to multiple charging stations. The target route information indicates from the current location to a target station among the charging stations.

Based on the above, the charging route planning method and the route processing apparatus of the embodiment of the disclosure decide target route information from the current location to the target (charging) station according to the initiation time of the charge request message, current battery level, and route information to multiple charging stations. In this way, appropriate charging station selection may be provided, and the efficiency of transportation scheduling may be improved.

To make the aforementioned more comprehensible, several embodiments accompanied with drawings are described in detail as follows.

### BRIEF DESCRIPTION OF THE DRAWINGS

The accompanying drawings are included to provide a further understanding of the disclosure, and are incorporated in and constitute a part of this specification. The drawings illustrate exemplary embodiments of the disclosure and, together with the description, serve to explain the principles of the disclosure.

FIG. 1 is a component diagram of a system according to an embodiment of the disclosure.

FIG. 2 is a schematic diagram of a transportation application scenario according to an embodiment of the disclosure.

FIG. 3 is a flowchart of a charging route planning methods according to an embodiment of the disclosure.

FIG. 4 is a schematic diagram illustrating various situations according to an embodiment of the disclosure.

FIG. 5 is a comparison diagram of completion rate between the embodiment of the disclosure and the existing technology.

FIG. 6 is a comparison diagram of time required for tasks between the embodiment of the disclosure and the existing technology.

### DESCRIPTION OF THE EMBODIMENTS

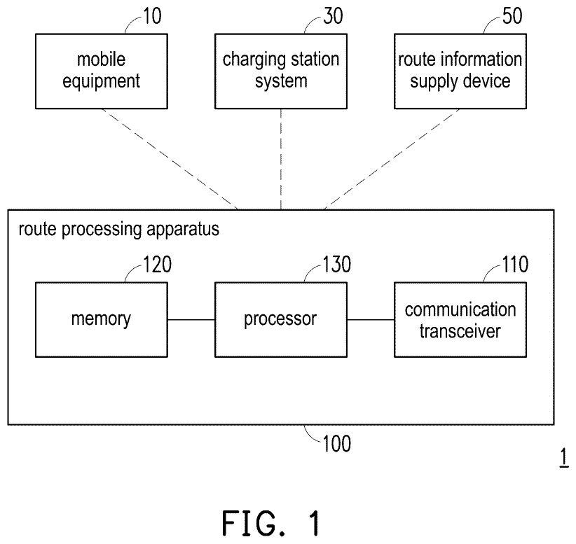

FIG. 1 is a component diagram of a system 1 according to an embodiment of the disclosure. Referring to FIG. 1, the system 1 includes (but is not limited to) one or more mobile equipment 10, one or more charging station information systems 30, one or more route information supply devices 50, and a route processing apparatus 100.

The mobile equipment 10 may be a mobile phone, tablet computer, laptop computer, voice assistant device, wearable device, vehicle-mounted system, or other electronic device. In one embodiment, the mobile equipment 10 is located on a vehicle. In another embodiment, the mobile equipment 10 is a vehicle-mounted system on the vehicle. The vehicle may be an electric vehicle or plug-in hybrid vehicle of motorcycle, automobile, bus, or other mobile carrier type.

The charging station system 30 includes one or more power supply equipment (for example, charging piles), battery exchange equipment, or combinations thereof. The power supply equipment may be used to provide electric power to electric vehicles or plug-in hybrid vehicles. The battery exchange equipment provides charging and placement for exchangeable batteries. The charging station system 30 may further include a computer system to monitor the operating status of the power supply equipment. For example, charging operation in progress, charging stopped, or no occupation.

The route information supply device 50 is a server or other computer system. In one embodiment, the route information supply device 50 provides at least one of the following functions: calculation of route distance and route travel time, route planning, traffic information, or road condition prediction. For example, when start point information and endpoint information are transmitted to an electronic map service server, the server may calculate and return the route distance and route travel time. It should be noted that route planning may consider road conditions, constraints (for example, avoiding highways or prioritizing energy conservation) or other factors, and the embodiment of the disclosure does not impose limitations.

The route processing apparatus 100 includes (but is not limited to) a communication transceiver 110, a memory 120, and a processor 130.

The communication transceiver 110 may be a communication transceiver supporting fourth generation (4G) or other generations of mobile communication, Wi-Fi, Bluetooth, infrared, Radio Frequency Identification (RFID), Ethernet, optical fiber network, etc., serial communication interface (such as RS-232), or may be Universal Serial Bus (USB), Thunderbolt or other communication transmission interfaces. In one embodiment, the communication transceiver 110 is used to transmit or receive data with other electronic devices (for example, mobile equipment 10, charging station system 30, or route information supply device 50).

The memory 120 may be any type of fixed or removable Random Access Memory (RAM), Read Only Memory (ROM), flash memory, Hard Disk Drive (HDD), Solid-State Drive (SSD), or similar components. In one embodiment, the memory 120 is used to store code, software modules, configuration settings, data (for example, messages, battery information/route information, or model parameters) or files, and its implementation will be described in detail later.

The processor 130 may be a Central Processing Unit (CPU), Graphic Processing Unit (GPU), or other programmable general-purpose or special-purpose Microprocessor, Digital Signal Processor (DSP), programmable controller, Field Programmable Gate Array (FPGA), Application-Specific Integrated Circuit (ASIC), neural network accelerator or other similar components or combinations of the above components. In one embodiment, the processor 130 is used to execute all or part of the operations of the route processing apparatus 100, and may load and execute various codes, software modules, files and data stored in the memory 120. In some embodiments, the functions of the processor 130 may be realized through software or chips.

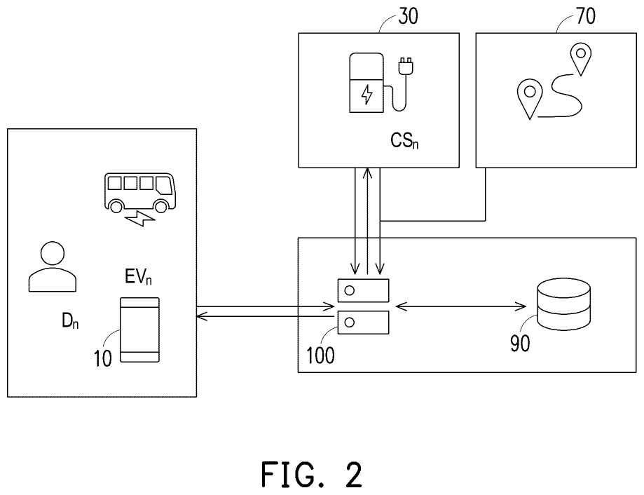

FIG. 2 is a schematic diagram of a transportation application scenario according to an embodiment of the disclosure. Referring to FIG. 2, the passenger transport is an electric vehicle EVₙ (n is a positive integer greater than zero), and the driver inside the electric vehicle EVₙ carries a mobile equipment 10 or the electric vehicle EVₙ is equipped with a mobile equipment 10. The mobile equipment 10 connects to a charging navigation system for electric buses provided by the route processing apparatus 100, and shares electric bus information. On the other hand, the charging station system 30 (distinguished as a charging station CSₙ) also connects to this charging navigation system to share availability information of charging equipment. The charging station CSₙ may be set up near the bus terminal, and there may be multiple charging stations near the bus terminal. According to actual needs, the route processing apparatus 100 may additionally connect to a database 90, and the database 90 may store information such as route information or power supply information.

However, the scenario shown in FIG. 2 is only used for exemplary explanation, and its quantity and function may still be adjusted according to actual needs.

In the following, the method described in the embodiment of the disclosure will be explained in conjunction with various systems, devices, components and modules in system 1. The processes of this method may be adjusted according to the implementation situation.

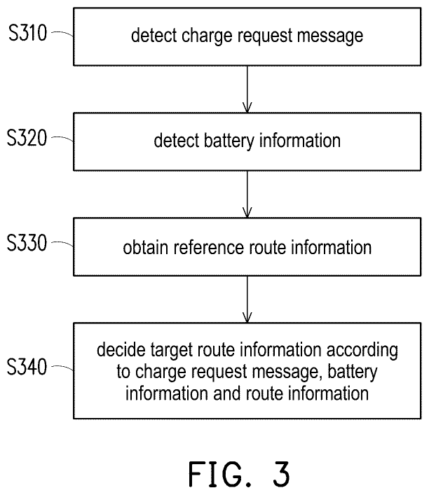

FIG. 3 is a flowchart of a charging route planning methods according to an embodiment of the disclosure. Referring to FIG. 3, the processor 130 detects a charge request message (step S310). Specifically, the mobile equipment 10 may emit a charge request message in response to user operation or trigger conditions. The mobile equipment 10 may provide message sending options, and the user operation is the operation of the user selecting the message sending function (for example, pressing or clicking on the message sending option on the user interface). The trigger conditions may include, but are not limited to, the current battery level of the vehicle being less than a corresponding threshold value, entering a specified time interval, or entering a specified geographic area. The processor 130 may receive the charge request message from the mobile equipment 10 through the communication transceiver 110 via the network.

In one embodiment, the charge request message corresponds to task period information, and the task period information indicates the initiation time of the charge request message. The initiation time may be the time of receiving user operation, meeting trigger conditions, or sending the message, and is not limited to these. It is assumed that the task is to complete the charging operation at the charging station CSₙ. Alternatively, it is assumed that the task is to reach the destination (which may be any specified location) after completing the charging operation at the charging station CSₙ. However, the content of the task may still be adjusted according to actual needs.

In one embodiment, the task period information corresponds to the time interval from the initiation time of the charge request message to the complete charging time. The complete charging time also represents the task completion time (point).

In one embodiment, the charge request message further indicates driving information. The driving information indicates the vehicle usage behavior of the driver. For example,

$$D = \{ {D}_{1} , {D}_{2} , ... , {D}_{n} \} \qquad ( 1 )$$

$$DR = \{ {DR}_{{D}_{1}} , {DR}_{{D}_{2}} , ... , {DR}_{{D}_{n}} \} \qquad ( 2 )$$

$${DR}_{{D}_{n}} = \{ {T}_{{D}_{n}}^{O} \} , \qquad ( 3 )$$

where Dis the set of driver information, Dₙis the n^{th} driver information, DR is the set of driver information, DR_{Dn} is the driving information corresponding to the n^{th} driver information, and

$${T}_{{D}_{n}}^{O}$$

is the occupancy information corresponding to the n^{th} driver information. The occupancy information is the charging occupancy behavior in the previous record. For example, the number of times the charging device is occupied.

The processor 130 detects battery information (step S320). Specifically, the battery information indicates the current battery level of the vehicle. This vehicle is the vehicle of the mobile equipment 10 that issues the charge request message. In one embodiment, the charge request message further indicates battery information. In another embodiment, the mobile equipment 10 transmits battery information to the route processing apparatus 100 periodically or non-periodically.

In one embodiment, the battery information further indicates the target battery level corresponding to the charge request message. The target battery level may be a value selected by user operation or a preset value.

In one embodiment, the battery information further indicates charging specification information. The charging specification information indicates at least one of the following: battery capacity or socket type. For example,

$$IV = \{ {IV}_{1} , {IV}_{2} , ... , {IV}_{n} \} \qquad ( 4 )$$

$${IV}_{n} = \{ {BC}_{{EV}_{n}} , {S}_{{EV}_{n}}^{type} \} , \qquad ( 5 )$$

where IV is the set of charging specification information of the electric vehicle, IVₙ is the charging specification information of the n^{th} electric vehicle EVₙ, BC_{EV}_{ₙ} is the battery capacity corresponding to the charging specification information of the n^{th} electric vehicle EVₙ, and

$${S}_{{EV}_{n}}^{type}$$

is socket type corresponding to the charging specification information of the n^{th} electric vehicle EVₙ.

In one embodiment, the processor 130 obtains charging station information through the communication transceiver 110. The charging station system 30 transmits charging station information. For example,

$$CS = \{ {CS}_{1} , {CS}_{2} , ... , {CS}_{n} \} \qquad ( 6 )$$

$${CS}_{n} = \{ {L}_{{CS}_{n}}^{lng} , {L}_{{CS}_{n}}^{lat} , {S}_{{CS}_{n}}^{type} , {S}_{{CS}_{n}} , {A}_{{CS}_{n}} \} , \qquad ( 7 )$$

where CSₙ is the n^{th} charging station,

$${L}_{{CS}_{n}}^{lng}$$

corresponds to the longitude of the n^{th} charging station CSₙ

$${L}_{{CS}_{n}}^{lat}$$

corresponds to the latitude of the n^{th} charging station CSₙ, is the socket

$${S}_{{CS}_{n}}^{type}$$

is the socket type provided by the n^{th} charging stationCSₙ, S_{CS}_{ₙ} is the quantity of power supply equipment provided by the n^{th} charging stationCSₙ, and A_{CS}_{ₙ} represents whether the n^{th} charging station CSₙ is in an operational state.

The processor 130 obtains reference route information (step S330). Specifically, the reference route information indicates the route from the current location where the charge request message is initiated to multiple charging stations. The processor 130 may transmit the current location of the vehicle (and the locations of multiple charging stations) to the route information supply device 50 through the communication transceiver 110. The route information supply device 50 may output the corresponding reference route information. For example, the reference route information indicates the route distance and travel time from the current location to multiple charging stations. For example, the route information supply device 50 provides an application program interface (API), and is used to provide reference route information according to the starting location and endpoint location. The reference route information may be, for example:

$$RP = \{ {L}_{o}^{lng} , {L}_{o}^{lat} , {L}_{d}^{lng} , {L}_{d}^{lat} , {D}_{o , d} , {T}_{o , d}^{D} \} , \qquad ( 8 )$$

where RP refers to the reference route information,

$${L}_{o}^{lng} and {L}_{o}^{lat}$$

represent the longitude and latitude of the origin location (for example, the current geographical coordinates of the vehicle),

$${L}_{d}^{lng} and {L}_{d}^{lat}$$

represent the longitude and latitude of the destination location (for example, the geographical coordinates of the charging station), D_{o,d} is the route distance, and

$${T}_{o , d}^{D}$$

is the travel time from the origin location to the destination location.

In one embodiment, the reference route information further indicates the route from multiple charging stations to the destination corresponding to the charge request message. The destination may exemplify a bus terminal, the driver's home, or other locations. The processor 130 may transmit the locations of multiple charging stations and the location of the destination to the route information supply device 50 through the communication transceiver 110. The route information supply device 50 may output the corresponding route information. For example, the reference route information indicates the route distance and travel time from multiple charging stations to the destination.

In one embodiment, the processor 130 may compile various information into the charge request information. For example,

$$CR = \{ {CR}_{1} , {CR}_{2} , ... , {CR}_{n} \} \qquad ( 9 )$$

$${CR}_{n} = \{ {T}_{n}^{CR} , {T}_{n}^{TF} , {BC}_{{EV}_{n}} , {S}_{{EV}_{n}}^{type} , {SOC}_{n}^{C} , {SOC}_{n}^{T} , {L}_{{o}_{n}}^{lat} , {L}_{{o}_{n}}^{lng} , {L}_{{d}_{n}}^{lat} , {L}_{{d}_{n}}^{lng} \} , \qquad ( 10 )$$

where CR is the set of charging request information, CRₙ is the charging request information of the n^{th} electric vehicle EVₙ,

$${T}_{n}^{CR}$$

is the initiation time of the charge request message,

$${T}_{n}^{TF}$$

is the complete charging time (representing the latest time point by which charging must be completed), BC_{EV}_{ₙ} is the battery capacity corresponding to the n^{th} charging specification information (where m is a positive integer greater than zero),

$${S}_{{EV}_{n}}^{type}$$

is the socket type corresponding to the n^{th} charging request information,

$${SOC}_{n}^{C}$$

is the target charge level (percentage) corresponding to the n^{th} charging request information

$${SOC}_{n}^{T}$$

is the target charge level (percentage) corresponding to the n^{th} charging request information,

$${L}_{{o}_{n}}^{lat}$$

is the latitude of the starting location (i.e., current location) corresponding to the n^{th} charging request information,

$${L}_{{o}_{n}}^{l n g}$$

is the longitude of the starting location (i.e., current location) corresponding to the n^{th} charging request information,

$${L}_{{d}_{n}}^{lat}$$

is the latitude or the destination location (i.e., destination position) corresponding to the n^{th} charging request information, and

$${L}_{{d}_{n}}^{l n g}$$

g is the longitude of the destination location (i.e., destination position) corresponding to the n^{th} charging request information.

In addition,

$${D}_{{o}_{n} , {CS}_{m}} , {T}_{{o}_{n} {CS}_{m}}^{D} = R ( {L}_{{o}_{n}}^{lat} , {L}_{{o}_{n}}^{l n g} , {L}_{{CS}_{m}}^{lat} , {L}_{C {S}_{m}}^{l n g} ) , \qquad ( 11 )$$

where Dₒ_{ₙ}_{,CS}_{ₘ} represents the route distance from the starting location corresponding to the n^{th} charging request information to the m^{th} charging station,

$${T}_{{o}_{n} , {CS}_{m}}^{D}$$

represents the travel time from the starting location corresponding to the n^{th} charging request information to the m^{th} charging station, and R(.) is a function or rule used to calculate route distances and travel times.

$${D}_{C {S}_{m} , {d}_{n}} , {T}_{{CS}_{m} , {d}_{n}}^{D} = R ( {L}_{C {S}_{m}}^{lat} , {L}_{C {S}_{m}}^{l n g} , {L}_{{d}_{n}}^{lat} , {L}_{{d}_{n}}^{l n g} ) , \qquad ( 12 )$$

wherein D_{CS}_{ₘ}_{,d}_{ₙ} represents the route distance from the m^{th} charging station to the destination location corresponding to the n^{th} charging request information, represents the travel time

$${T}_{{o}_{n} , {CS}_{m}}^{D}$$

represents the travel time from the m^{th} charging station to the destination location corresponding to the n^{th} charging request information.

$${D}_{{CS}_{m}}^{T} = {D}_{{o}_{n} , {CS}_{m}} + {D}_{C {S}_{m} , {d}_{n}} , \qquad ( 13 )$$

where,

$${D}_{{CS}_{m}}^{T}$$

represents the Tour distance from the starting location corresponding to the n^{th} charging request information, passing through the m^{th} charging station, and arriving at the destination location corresponding to the n^{th} charging request information.

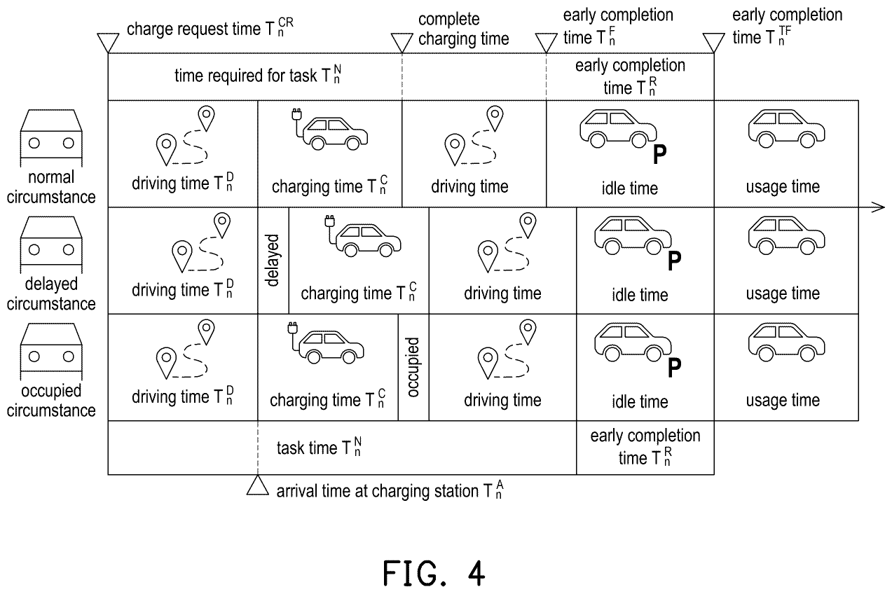

In one embodiment, the processor 130 may predict task period information. The task period information corresponds to the time interval from the initiation time of the charge request message to the complete charging time, and the complete charging time is decided according to the initiation time of the charge request message, the battery information, and the reference route information. For example, FIG. 4 is a schematic diagram illustrating various situations according to an embodiment of the disclosure. Referring to FIG. 4, the processor 130 may decide the charging period according to the battery information, and the battery information further indicates the target battery level corresponding to the charge request message:

$${T}_{n}^{C} = \frac{B {C}_{n} \times ( {SOC}_{n}^{T} - {SOC}_{n}^{C} ) + {D}_{{o}_{n} , {CS}_{m}} \times α}{β} , \qquad ( 14 )$$

where

$${T}_{n}^{C}$$

represents the charging period, BCₙ corresponds to the total battery capacity associated with the n^{th} charging request information,

$${SOC}_{n}^{C}$$

is the current state of charge (expressed as a percentage) associated with the n^{th} charging request information,

$${SOC}_{n}^{T}$$

indicates the target state of charge (expressed as a percentage) associated with the n^{th} charging request information, Dₒ_{ₙ}_{,CS}_{ₘ} is the route distance from the initial location corresponding to the n^{th} charging request information to the m^{th} charging station, a represents the energy consumption rate required for traveling, and β denotes the charging speed rate.

The processor 130 may decide the driving period according to the reference route information. For example,

$${T}_{n}^{D} = \frac{{D}_{{CS}_{m}}^{T}}{{SP}_{t}} , \qquad ( 15 )$$

where

$${T}_{n}^{D}$$

represents the vehicle's travel time,

$${D}_{{CS}_{m}}^{T}$$

denotes the route distance from the starting location corresponding to the n^{th} charging request information, passing through the m^{th} charging station, and arriving at the destination location corresponding to the n^{th} charging request information, and SPₜ is the average speed of the vehicle.

Next, the processor 130 may decide the complete charging time according to the charging period and the driving period. For example,

$${T}_{n}^{A} = {T}_{n}^{CR} + {T}_{{o}_{n} , {CS}_{m}}^{D} , \qquad ( 16 )$$

where

$${T}_{n}^{A}$$

represents the arrival time of the vehicle at the charging station,

$${T}_{n}^{CR}$$

denotes the vehicle's travel time, and

$${T}_{{o}_{n} , {CS}_{m}}^{D}$$

indicates the travel duration from the initial location corresponding to the n^{th} charging request information to the m^{th} charging station.

$${T}_{n}^{F} = {T}_{n}^{CR} + {T}_{n}^{N} , \qquad ( 17 )$$

where

$${T}_{n}^{F}$$

is the complete charging time,

$${T}_{n}^{CR}$$

is the imitation time or the charge request message, and

$${T}_{n}^{N}$$

is the time required for the task (for example, the time interval from the initiation of the charge request message to the completion of charging).

$${T}_{n}^{N} = {T}_{n}^{D} + {T}_{n}^{C} \qquad ( 18 )$$

where

$${T}_{n}^{N}$$

represents the time required for the task,

$${T}_{n}^{D}$$

represents the vehicle's driving time, and

$${T}_{n}^{C}$$

represents the charging period.

$${T}_{n}^{R} = {T}_{n}^{TF} - {T}_{n}^{F} , \qquad ( 19 )$$

where

$${T}_{n}^{R}$$

represents early completion time or idle time,

$${T}_{n}^{TF}$$

represents the target completion time point, and

$${T}_{n}^{F}$$

represents the charging completion time. That is, the early completion time or idle time is the time interval from the charging completion time to the target completion time point.

Furthermore, the waiting time

$${T}_{n}^{L}$$

represents the interval during which a vehicle arrives at the charging station and experiences waiting and delay (as shown in the “delayed” section in FIG. 4). The occupation time

$${T}_{n}^{O}$$

represents the interval during which a vehicle occupies the charging station (as shown in the “occupied” section in FIG. 4). In one embodiment, the processor 130 further obtains occupation information. The occupation information comprises charging occupation behaviors from previous records, and the complete charging time may be determined based on the occupation information. For example, the duration of the occupation time within the complete charging time may be determined according to the frequency of charging occupation behaviors.

In one embodiment, the charging station information indicates the quantity of chargeable quantity at those charging stations. In order for the vehicle to select a charging station, the quantity of available power supply equipment in the charging station (i.e., chargeable quantity) may also be considered. The available charging quantity of the charging station may be updated in real time. For example,

$${S}_{n}^{{T}^{A}} = {S}_{{CS}_{n}} - {EV}_{{CS}_{n}}^{C} , \qquad ( 20 )$$

where

$${S}_{n}^{{T}^{A}}$$

represents the available charging quantity, S_{CS}_{ₙ} denotes the number of charging equipment provided at the n^{th} charging station CSₙ, and

$${EV}_{{CS}_{n}}^{C}$$

indicates the number of vehicles charging at the n^{th} charging station CSₙ (which may include reserved quantities). Taking into account different time periods:

$${S}_{j}^{A} = \{ {S}_{n}^{{T}^{A} + t} \} , ∀ t ∈ T \qquad ( 21 )$$

where

$${S}_{j}^{A}$$

represents the set of time periods with available charging capacity at charging station j, and

$${S}_{n}^{{T}^{A} + t}$$

represents the available charging capacity during time period t.

Referring to FIG. 3, the processor 130 decides the target route information according to the charge request message, the battery information, and the reference route information (step S340). Specifically, the target route information indicates from the current location to the target station among multiple charging stations. That is, the processor 130 analyzes the charge request message, the battery information, and the reference route information, and decides the corresponding target route information, which is used to select the target station.

In one embodiment, the processor 130 may input the charge request message, the battery information, and the reference route information to a machine learning model. The machine learning model may be based on Deep Reinforcement Learning (DRL) (for example, Deep Q Network (DQN), Convolutional Neural Network (CNN), or Generative Adversarial Network (GAN)), and not limited thereto. The machine learning model is established through learning the association between task duration information, current battery level, multiple reference routes, and the marked routes among these reference routes. For example, the training samples include known task duration information, known battery information, reference route information, and known selected charging stations. The machine learning model understands the association between the known task duration information, the known battery information, the reference route information, and the known target station during the learning process. The machine learning algorithm may analyze the relationship between training samples (for example, dataset) and corresponding labels (for example, a certain charging station) or actual results to obtain patterns, thereby predicting unknown data through these patterns. The machine learning model may be used to infer on data to be evaluated (for example, charge request message, battery information, and reference route information) to generate prediction results. This prediction result is one or more charging stations and their confidence scores. The confidence score reflects the confidence of the machine learning model in the predicted charging station and/or the accuracy of the prediction. If a charging station has a higher confidence score, it means there is higher confidence that this charging station is correctly predicted. And the charging station with the highest confidence score may serve as the target station. If a charging station has a lower confidence score, it means there is lower confidence that this charging station is correctly predicted.

In one embodiment, the processor 130 may decide the target route information according to the charge request message, the battery information, the route information, and the charging station information. For example,

$${s}_{t}^{n} = \{ {T}_{n}^{CR} , {T}_{n}^{TF} , {SOC}_{n}^{C} , {SOC}_{n}^{T} , {CS}_{t}^{( info )} \} \qquad ( 22 )$$

$${CS}_{t}^{( info )} = \{ {D}_{{CS}_{j}}^{T} , {T}_{n , j}^{T} , {S}_{j}^{A} \} , ∀ j ∈ J , \qquad ( 23 )$$

where

$${s}_{t}^{n}$$

represents the input data to the machine learning model,

$${T}_{n}^{CR}$$

denotes the initiation time of the charge request message,

$${T}_{n}^{TF}$$

signifies the target completion time,

$${SOC}_{n}^{C}$$

indicates the vehicle's current state of charge,

$${SOC}_{n}^{T}$$

corresponds to the target state of charge associated with the charge request message,

$${CS}_{t}^{( info )}$$

refers to the charging station information,

$${D}_{{CS}_{j}}^{T}$$

represents the route distance from the starting location through the j^{th} charging station to the destination,

$${T}_{n , j}^{T}$$

denotes the travel time from the starting location associated with the n^{th} charging request information through the j^{th} charging station to the destination location associated with the n^{th} charging request information, and

$${S}_{j}^{A}$$

constitutes the set of time periods for the available charging capacity at the j^{th} charging station.

In one embodiment, the processor 130 may perform data transformation on the input data through standardization and/or normalization. The processor 130 may select the transformation method according to the data characteristics of the input data to improve the convergence speed of the model. For the time data portion, the processor 130 may perform data transformation through normalization. For example, converting time-related data to values between 0 and 1 to improve convergence speed. For other data portions, the processor 130 may perform data transformation through standardization. For example, using Z-Score as the standardization method. This method reduces the feature range of the data, making the model easier to converge during training.

In machine learning models, exemplified by DQN, three critical inputs are state, action, and reward function. The state refers to the condition of the environment, which can be any information that describes the environment, such as the input data sₜⁿ.

In one embodiment, the processor 130 may set multiple action information. Each action information indicates a selection behavior of one of multiple charging stations. Action is the operation that the Agent can take in the environment. For example,

$${a}_{t} = \{ {a}_{1} , {a}_{2} , ... , {a}_{j} \} , \qquad ( 24 )$$

where aₜ represents action information, and aⱼ denotes the action of selecting the j^{th} charging station.

In one embodiment, the processor 13 may decide the reward information according to the charge request message, battery information, and reference route information. The reward information indicates the reward obtained by selecting multiple action information, and the reward information is used to retrain the machine learning model. During the model training process, the collected data is divided into training group and testing group. The training group is put into model training, and different reward values are obtained by selecting different actions. The machine learning model will record what action is the best in different states. After the training of the training group is completed, the testing group is used to verify whether the machine learning model has been trained as required (i.e., whether the most suitable action has been selected). If the requirement is achieved, it is decided that the machine learning model has completed training.

The reward information indicates the reward obtained by the Agent after taking action in the environment. In one embodiment, the processor 130 corresponds a shorter task period to a higher reward value, and corresponds a longer task period to a lower reward value. For example, the reward function is shown in formula (25), and the goal of the formula design is to complete the task time earliest and arrive at the charging station earliest.

$${r}_{t} ( {s}_{t}^{n} , {a}_{t} ) = \{ \begin{matrix}- 1 , & {T}_{n}^{R} \leq 0 \\ {T}_{n}^{R} - {T}_{n}^{D} + 2 , & {T}_{n}^{R} > 0\end{matrix} , \qquad ( 25 )$$

where rₜ( ) is the reward function,

$${s}_{t}^{n}$$

represents the input data or state, aₜ represents action information,

$${T}_{n}^{R}$$

refers to the early completion time or idle time for the n^{th} charging, and

$${T}_{n}^{D}$$

refers to the travel time for the n^{th} charging. When the time from charging completion to the target completion time is less than or equal to zero, it represents a longer task duration (i.e., no early completion time or idle time), thus a reward value of −1 is given. Whereas when the time from charging completion to the target completion time is greater than zero, it represents a shorter task duration (i.e., longer early completion time or idle time), thus a reward value greater than zero is given.

Reward function examples include, Reward Function (1):

$${T}_{n}^{N} - {T}_{n}^{D} + 2$$

(calculated by subtracting driving time from task duration, aiming to minimize driving time while ensuring task completion) or Reward Function (2):

$${T}_{n}^{R} - {T}_{n}^{D} + 2$$

(designed to reward earlier completion times and shorter driving durations). Table (1) presents the experimental data results, with a total dataset of 8,651 entries (including 8,204 training samples and 447 test samples):

TABLE 1

| reward | | | |
|---|---|---|---|
| function | model learning rate | completion rate | reward value |
| 1 | 0.001 | 92.4% | 3028 |
| | 0.0005 | 92.2% | 2820 |
| 2 | 0.001 | 93.0% | 2368 |
| | 0.0005 | 94.2% | 3271 |

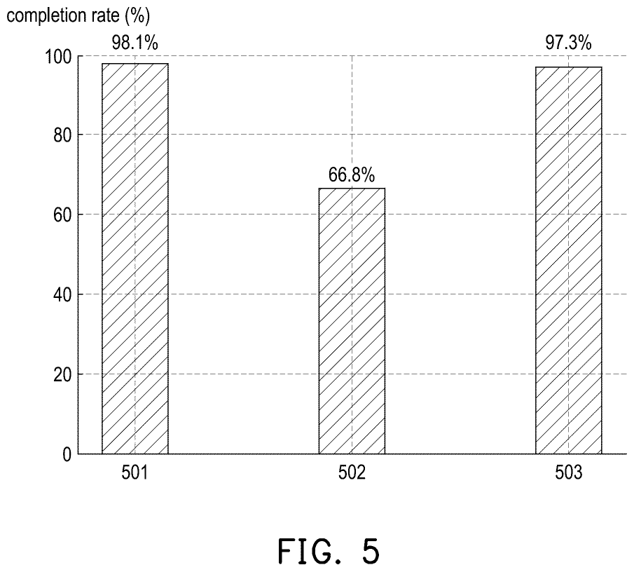

FIG. 5 is a comparison diagram of completion rate between the embodiment of the disclosure and the existing technology. Referring to FIG. 5, for the comparison of task completion rate (for example, charging within the arranged time and reaching the target battery level is defined as task completion, and the ratio of the number of completed tasks to the total statistical quantity is counted), the higher the task completion rate, the closer to the target, and the higher the scheduling and charging efficiency. The task completion rate of the embodiment 501 of the disclosure is higher than that of using the RLCharge model 502 and the Nearest method 503.

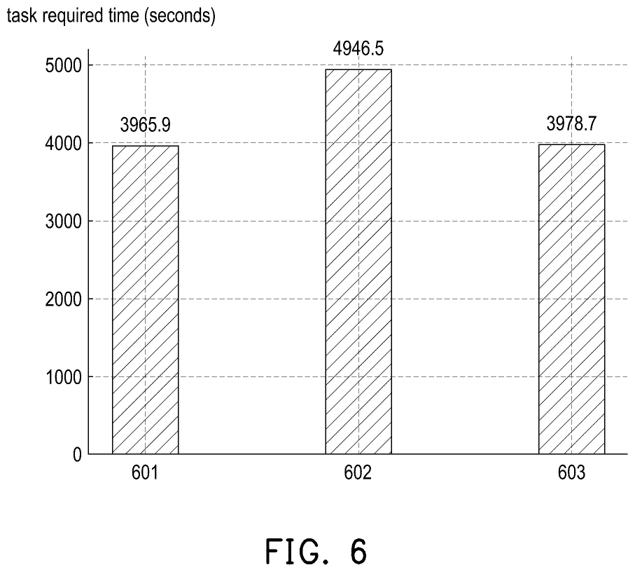

FIG. 6 is a comparison diagram of time required for tasks between the embodiment of the disclosure and the existing technology. Referring to FIG. 6, for the comparison of the time required for the task, the shorter the time required for the task, the closer to the target, and the higher the scheduling and charging efficiency. The time required for the task of the embodiment 601 of the disclosure is shorter than that of using the RLCharge model 602 and the Nearest method 603.

In an embodiment, the processor 130 may transmit the control command according to the target route information through the communication transceiver 110. This control command is used to drive the vehicle. For example, the vehicle system generates navigation information on the user interface according to the control command. For another example, the vehicle system drives the motor and steering wheel according to the control command, making the vehicle drive.

In summary, in the charging route planning method and the route processing apparatus of the embodiment of the disclosure, the task period information, battery information, reference route information and charging station information are comprehensively considered, and suitable charging stations and routes to reach the charging stations are provided. Thereby, it may improve charging convenience and satisfaction, enhance scheduling and charging efficiency, and further promote the development of the electric vehicle market.

It will be apparent to those skilled in the art that various modifications and variations can be made to the disclosed embodiments without departing from the scope or spirit of the disclosure. In view of the foregoing, it is intended that the disclosure covers modifications and variations provided that they fall within the scope of the following claims and their equivalents.

1. A charging route planning method, configured for a processor, the planning method comprising:
detecting a charge request message, wherein the charge request message corresponds to a task period information, and the task period information indicates an initiation time of the charge request message;
detecting a battery information, wherein the battery information indicates a current battery level;
obtaining a reference route information, wherein the reference route information indicates a route from a current location where the charge request message is issued to a plurality of charging stations;
deciding a target route information according to the charge request message, the battery information, and the reference route information, wherein the target route information indicates a route from the current location to a target station among the plurality of charging stations; and
transmitting, to a vehicle system, a control command according to the target route information, wherein the vehicle system is configured to drive a vehicle according to the control command,
wherein deciding the target route information according to the charge request message, the battery information, and the reference route information comprises:
inputting the charge request message, the battery information, and the reference route information to a machine learning model, wherein the machine learning model is established through learning association between the task period information, the current battery level, a plurality of reference routes, and a marked route among the reference routes;
setting a plurality of action information, wherein each of the action information indicates a selection behavior of one of the charging stations; and
deciding a reward information according to the charge request message, the battery information, and the reference route information, wherein the reward information indicates a reward obtained by selecting the action information, and the reward information is configured to retrain the machine learning model; and
using the machine learning model to output the target route information.

2. (canceled)

3. (canceled)

4. The charging route planning method according to claim 1, wherein deciding the reward information according to the charge request message, the battery information, and the reference route information comprises:
corresponding the task period that is shorter to a higher reward value; and
corresponding the task period that is longer to a lower reward value.

5. The charging route planning method according to claim 1, further comprising:
predicting the task period information, wherein the task period information corresponds to a time interval from an initiation time of the charge request message to a complete charging time, and the complete charging time is decided according to the initiation time of the charge request message, the battery information, and the reference route information.

6. The charging route planning method according to claim 5, further comprising:
deciding a charging time according to the battery information, wherein the battery information further indicates a target battery level corresponding to the charge request message;
deciding a driving period according to the reference route information; and
deciding the complete charging time according to the charging period and the driving period.

7. The charging route planning method according to claim 5, further comprising:
obtaining an occupation information, wherein the occupation information is a charging occupation behavior in a previous record, and the complete charging time is also decided according to the occupation information.

8. The charging route planning method according to claim 1, wherein the reference route information further indicates a route from the charging stations to a destination corresponding to the charge request message.

9. The charging route planning method according to claim 1, further comprising:
obtaining a charging station information, wherein the charging station information indicates a chargeable quantity of the charging stations, and deciding the target route information according to the charge request message, the battery information, and the reference route information comprises:
deciding a target route information according to the charge request message, the battery information, the route information, and the charging station information.

10. (canceled)

11. A route processing apparatus, comprising:
a memory, storing a program code; and
a processor, coupled to the memory, loading the program code and executing:
detecting a charge request message, wherein the charge request message corresponds to a task period information, and the task period information indicates an initiation time of the charge request message;
detecting a battery information, wherein the battery information indicates a current battery level;
obtaining a reference route information, wherein the reference route information indicates a route from a current location where the charge request message is issued to a plurality of charging stations;
deciding a target route information according to the charge request message, the battery information, and the reference route information, wherein the target route information indicates a route from the current location to a target station among the plurality of charging stations; and
transmitting, to a vehicle system, a control command according to the target route information, wherein the vehicle system is configured to drive a vehicle according to the control command,
wherein deciding the target route information according to the charge request message, the battery information, and the reference route information comprises:
inputting the charge request message, the battery information, and the reference route information to a machine learning model, wherein the machine learning model is established through learning association between the task period information, the current battery level, a plurality of reference routes, and a marked route among the reference routes;
setting a plurality of action information, wherein each of the action information indicates a selection behavior of one of the charging stations; and
deciding a reward information according to the charge request message, the battery information, and the reference route information, wherein the reward information indicates a reward obtained by selecting the action information, and the reward information is configured to retrain the machine learning model; and
using the machine learning model to output the target route information.

12. (canceled)

13. (canceled)

14. The route processing apparatus according to claim 11, wherein the processor further executes:
corresponding the task period that is shorter to a higher reward value; and
corresponding the task period that is longer to a lower reward value.

15. The route processing apparatus according to claim 11, wherein the processor further executes:
predicting the task period information, wherein the task period information corresponds to a time interval from an initiation time of the charge request message to a complete charging time, and the complete charging time is decided according to the initiation time of the charge request message, the battery information, and the reference route information.

16. The route processing apparatus according to claim 15, wherein the processor further executes:
deciding a charging time according to the battery information, wherein the battery information further indicates a target battery level corresponding to the charge request message;
deciding a driving period according to the reference route information; and
deciding the complete charging time according to the charging period and the driving period.

17. The route processing apparatus according to claim 15, wherein the processor further executes:
obtaining an occupation information, wherein the occupation information is a charging occupation behavior in a previous record, and the complete charging time is also decided according to the occupation information.

18. The route processing apparatus according to claim 11, wherein the reference route information further indicates a route from the charging stations to a destination corresponding to the charge request message.

19. The route processing apparatus according to claim 11, wherein the processor further executes:
obtaining a charging station information, wherein the charging station information indicates a chargeable quantity of the charging stations; and
deciding a target route information according to the charge request message, the battery information, the route information, and the charging station information.

20. (canceled)
